(19) United States
(12) Patent Application Publication
(10) Pub. No.: US 2026/0055853 A1
(43) Pub. Date: Feb. 26, 2026

(54) CRYOGENIC LIQUID STORAGE APPARATUS

(71) Applicants: Hyundai Motor Company, Seoul (KR); Kia Corporation, Seoul (KR)

(72) Inventors: Sang Moo Han, Hwaseong (KR); Jung Woon Choi, Incheon (KR)

(21) Appl. No.: 19/051,542

(22) Filed: Feb. 12, 2025

(30) Foreign Application Priority Data
Aug. 20, 2024 (KR) 10-2024-0111413

(51) Int. Cl. F17C 13/02; F17C 3/08

(52) U.S. Cl. CPC F17C 13/02; F17C 3/08; F17C 2203/0391; F17C 2203/0629; F17C 2221/012; F17C 2223/0161; F17C 2250/0417; F17C 2250/0491; F17C 2270/0168; F17C 2270/0184

(57) ABSTRACT

A cryogenic liquid storage apparatus includes a storage container configured to accommodate a cryogenic liquid and having a connection port, a level sensor configured to detect a liquid level of the cryogenic liquid on the basis of capacitance, and a connector part configured to selectively separably fasten the level sensor to the connection port, thereby obtaining an advantageous effect of providing ease of maintenance and repair and improving stability and reliability.

### CROSS-REFERENCE TO RELATED APPLICATION

This application claims under 35 U.S.C. § 119(a) the benefit of Korean Patent Application No. 10-2024-0111413 filed in the Korean Intellectual Property Office on Aug. 20, 2024, the entire contents of which are incorporated herein by reference.

### BACKGROUND

### Technical Field

The present disclosure relates to a cryogenic liquid storage apparatus and a liquid level measurement device, and more particularly, to a cryogenic liquid storage apparatus and a liquid level measurement device that are capable of being easily maintained and repaired and improving stability and reliability.

### Background

A fuel cell system refers to a system that produces electrical energy by means of a redox reaction between hydrogen and oxygen. Research and development have been consistently performed on the fuel cell system as an alternative capable of solving global environmental issues.

Recently, in order to increase an energy storage density per unit volume of fuel (e.g., hydrogen) used for the fuel cell system, various attempts have been made to store hydrogen in a liquid state (liquid hydrogen) at cryogenic temperatures (e.g., 20 to 33 K) in a storage container and supply a fuel cell stack with the hydrogen (liquid hydrogen or gaseous hydrogen) stored in the storage container.

Meanwhile, in order to efficiently operate the fuel cell stack, it is necessary to accurately adjust the amount of vaporized cryogenic liquid (liquid hydrogen) stored in the storage container and a pressure in the storage container in response to operating conditions of the fuel cell stack. To this end, it is necessary to accurately detect the amount of stored cryogenic liquid.

In the related art, a method of detecting a liquid level of a cryogenic liquid by using a level sensor configured to measure a change in capacitance in accordance with a level (liquid level) of liquid hydrogen has been proposed.

However, in the related art, because the level sensor is fixed to a storage container by welding, there is a problem in that it is very cumbersome and inconvenient to repair and replace the level sensor when the level sensor is damaged.

In particular, in the related art, a welded portion of the level sensor needs to be inevitably cut to replace the level sensor. However, in case that the storage container is damaged during the process of cutting the welded portion, there is a problem in that thermal insulation performance and sealability of the storage container are degraded, and safety and reliability are degraded.

Therefore, recently, various studies have been conducted to make it easy to maintain and repair a cryogenic liquid storage apparatus and improve stability and reliability, but the study results are still insufficient. Accordingly, there is a need to develop a technology to make it easy to maintain and repair the cryogenic liquid storage apparatus and improve stability and reliability.

### SUMMARY

The present disclosure has been made in an effort to provide a cryogenic liquid storage apparatus capable of being easily maintained and repaired and improving stability and reliability.

In particular, the present disclosure has been made in an effort to selectively separably fasten a level sensor to a storage container.

Among other things, the present disclosure has been made in an effort to selectively mount or separate the level sensor to or from the storage container without performing a welding process.

The present disclosure has also been made in an effort to ensure thermal insulation and sealability of the cryogenic liquid storage apparatus.

In particular, the present disclosure has been made in an effort to minimize deformation of a sealing part, which is configured to seal a periphery of a portion to which the level sensor is connected, and to ensure sealability.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides a cryogenic liquid storage apparatus including: a storage container configured to accommodate a cryogenic liquid and having a connection port; a level sensor configured to detect a liquid level of the cryogenic liquid on the basis of capacitance; and a connector part configured to selectively separably fasten the level sensor to the connection port.

This is to easily maintain and repair the cryogenic liquid storage apparatus and improve stability and reliability.

That is, in the related art, because the level sensor is fixed to a storage container by welding, there is a problem in that it is very cumbersome and inconvenient to repair and replace the level sensor when the level sensor is damaged.

In particular, in the related art, a welded portion of the level sensor needs to be inevitably cut to replace the level sensor. However, in case that the storage container is damaged during the process of cutting the welded portion, there is a problem in that thermal insulation performance and sealability of the storage container are degraded, and safety and reliability are degraded.

In contrast, according to the embodiment of the present disclosure, the level sensor may be selectively mounted in or separated from the storage container by means of the connector part. Therefore, it is possible to obtain an advantageous effect of simplifying a process of assembling and maintaining and repairing the level sensor and improving workability and productivity.

Moreover, according to the embodiment of the present disclosure, the level sensor may be attached to or detached from the storage container by means of the connector part without performing separate welding and cutting processes. Therefore, it is possible to obtain an advantageous effect of minimizing damage to the storage container when the level sensor is replaced and stably ensuring thermal insulation performance and sealability of the storage container.

The storage container may have various structures capable of storing the cryogenic liquid.

According to the exemplary embodiment of the present disclosure, the storage container may include: an inner container configured to accommodate the cryogenic liquid; and an outer container configured to surround a periphery of the inner container, and the connection port may be provided in the outer container.

According to the exemplary embodiment of the present disclosure, the storage container may include a vacuum thermal insulation layer defined between the inner container and the outer container.

Various capacitive sensors capable of detecting the liquid level of the cryogenic liquid on the basis of capacitance may be used as the level sensor.

According to the exemplary embodiment of the present disclosure, the level sensor may include a first electrode member, and a second electrode member accommodated in the first electrode member and electrically separated from the first electrode member.

The connector part may have various structures capable of selectively separably fastening the level sensor to the connection port.

According to the exemplary embodiment of the present disclosure, the connector part may include a first connector configured to support one end of the first electrode member and one end of the second electrode member and seated in the connection port, and a second connector configured to secure (fasten) the first connector to the connection port.

The first connector may have various structures capable of supporting one end of the first electrode member and one end of the second electrode member and being seated in the connection port.

According to the exemplary embodiment of the present disclosure, the first connector may include: a connector block electrically connected to the first electrode member and seated in the connection port; a first terminal electrically connected to the connector block and protruding from a reference surface of the connector block; and a second terminal electrically separated from the first terminal, electrically connected to the second electrode member, and protruding from the reference surface of the connector block, and the second connector may secure the first connector to the connection port while exposing the first terminal and the second terminal to the outside.

According to the exemplary embodiment of the present disclosure, the cryogenic liquid storage apparatus may include a through-portion provided in the connector block. One end of the second terminal may be connected to the second electrode member, and the other end of the second terminal may pass through the through-portion and protrude from the reference surface.

According to the exemplary embodiment of the present disclosure, the cryogenic liquid storage apparatus may include an insulation member provided in the connector block and configured to support the second electrode member and the second terminal and insulate the second electrode member and the second terminal from the connector block.

The method of fastening the second connector and the connection port may be variously changed in accordance with required conditions and design specifications.

According to the exemplary embodiment of the present disclosure, the cryogenic liquid storage apparatus may include: a first screw thread portion provided on an outer peripheral surface of the connection port; and a second screw thread portion provided on an inner peripheral surface of the second connector and configured to engage with the first screw thread portion, in which the second connector secures the first connector to the connection port by means of a fastening force between the first screw thread portion and the second screw thread portion.

According to the exemplary embodiment of the present disclosure, the cryogenic liquid storage apparatus may include: a sealing part provided on the connector block and configured to surround a periphery of the first terminal and a periphery of the second terminal.

According to the exemplary embodiment of the present disclosure, the sealing part may be made of epoxy.

According to the exemplary embodiment of the present disclosure, the cryogenic liquid storage apparatus may include a guide rib protruding from the reference surface of the connector block and configured to surround the periphery of the first terminal and the periphery of the second terminal, and the sealing part may be configured to cover the guide rib.

This is based on the fact that because the sealing part (e.g., epoxy) and the first connector (e.g., metal) including the guide rib are made of materials with different thermal contraction ratios, the sealing performance implemented by the sealing part deteriorates when an interface between the sealing part and the guide rib is fractured (the sealing part and the guide rib are separated from each other) in the event of thermal contraction of the sealing part.

According to the embodiment of the present disclosure, because the sealing part covers the end of the guide rib, compressive stress may be applied to the guide rib so that the guide rib may be bent in response to the contraction of the sealing part (compressive stress may be applied to allow the guide rib to be bent in a direction in which the guide rib approaches the first terminal) when the sealing part contracts in a cryogenic environment. Therefore, it is possible to obtain an advantageous effect of minimizing the fracture of the interface between the sealing part and the guide rib (separation of the sealing part and the guide rib).

The sealing part may have various structures capable of covering the end of the guide rib while sealing the gap between the terminal block and the first terminal and the gap between the terminal block and the second terminal.

According to the exemplary embodiment of the present disclosure, the sealing part may include a first sealing portion configured to fill a gap between the through-portion and the second terminal, a second sealing portion integrally connected to the first sealing portion and configured to fill an interior of the guide rib, and a third sealing portion integrally connected to the second sealing portion and configured to cover an end of the guide rib.

According to the exemplary embodiment of the present disclosure, the sealing part may include a side sealing portion integrally connected to the third sealing portion and configured to cover a periphery of an outer surface of the guide rib.

As described above, in the embodiment of the present disclosure, the sealing part may be supported on the guide rib by means of the third sealing portion and the side sealing portion, such that compressive stress may be applied to the guide rib so that the guide rib may be more effectively bent in response to the contraction of the sealing part when the sealing part contracts in a cryogenic environment. Therefore, it is possible to obtain an advantageous effect of more effectively suppressing the fracture of the interface between the sealing part and the guide rib (separation of the sealing part and the guide rib).

According to the exemplary embodiment of the present disclosure, the side sealing portion may be provided to be spaced apart from the reference surface.

This is based on the fact that when the side sealing portion adheres to the peripheral structure (e.g., the reference surface), compressive stress cannot be effectively applied to the guide rib by the side sealing portion when the sealing part contracts. According to the embodiment of the present disclosure, the side sealing portion may be disposed to be spaced apart from the reference surface, which may prevent the side sealing portion and the peripheral structure (e.g., the reference surface) from being joined (coupled). Therefore, it is possible to obtain an advantageous effect of more effectively applying the compressive stress, which is applied by the side sealing portion, to the guide rib.

According to the exemplary embodiment of the present disclosure, a thickness of the guide rib in a longitudinal direction of the storage container may be defined as 2 mm or less.

This is based on the fact that when the thickness of the guide rib in the longitudinal direction of the storage container is larger than 2 mm, it is difficult to apply sufficient compressive stress to the guide rib, which may fracture the interface between the sealing part and the guide rib. According to the embodiment of the present disclosure, the thickness of the guide rib in the longitudinal direction of the storage container may be defined as 2 mm or less, such that flexibility of the guide rib may be ensured, and sufficient compressive stress may be applied to the guide rib. Therefore, it is possible to obtain an advantageous effect of minimizing the fracture of the interface between the sealing part and the guide rib.

According to the exemplary embodiment of the present disclosure, a thickness of the side sealing portion in a longitudinal direction of the storage container may be defined as 0.5 mm or more.

This is based on the fact that when the thickness of the side sealing portion in the longitudinal direction of the storage container is less than 0.5 mm, compressive stress cannot be effectively applied to the guide rib by the side sealing portion. According to the embodiment of the present disclosure, because the thickness of the side sealing portion in the longitudinal direction of the storage container is defined as 0.5 mm or more, it is possible to obtain an advantageous effect of more effectively applying the compressive stress, which is applied by the side sealing portion, to the guide rib.

According to the exemplary embodiment of the present disclosure, the cryogenic liquid storage apparatus may include: a sealing member interposed between the connection port and the first connector.

According to the exemplary embodiment of the present disclosure, the cryogenic liquid storage apparatus may include: a gland connected to the first connector and configured to press the sealing member against an end of the connection port.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 is a view for explaining a cryogenic liquid storage apparatus according to an embodiment of the present disclosure.

FIG. 2 is a view for explaining a connector part of the cryogenic liquid storage apparatus according to the embodiment of the present disclosure.

FIG. 3 is a view for explaining a sealing part of the cryogenic liquid storage apparatus according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

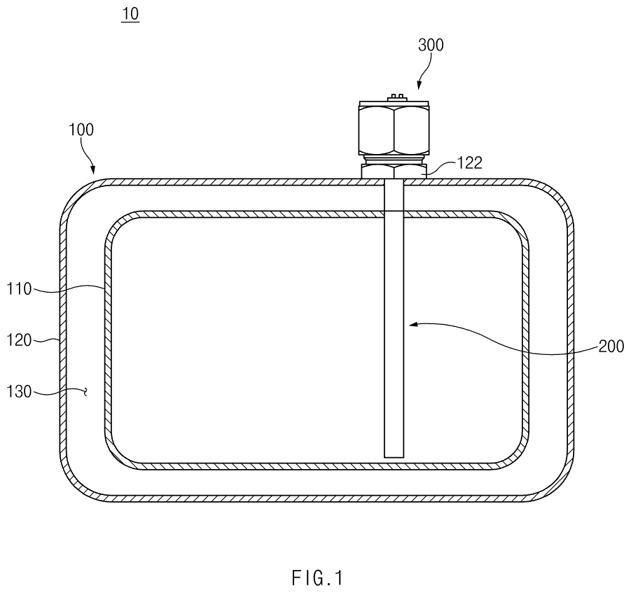

With reference to FIGS. 1 to 3, a cryogenic liquid storage apparatus 10 according to an embodiment of the present disclosure includes a storage container 100 configured to accommodate a cryogenic liquid and having a connection port 122, a level sensor 200 configured to detect a liquid level of the cryogenic liquid on the basis of capacitance, and a connector part 300 configured to selectively separably fasten the level sensor 200 to the connection port 122.

For reference, the cryogenic liquid storage apparatus 10 according to the embodiment of the present disclosure may be used to store various objects in accordance with required conditions and design specifications. The present disclosure is not restricted or limited by the type and properties of the object.

For example, the cryogenic liquid storage apparatus 10 according to the embodiment of the present disclosure may be used to store fuel (e.g., liquid hydrogen) used for mobility vehicles such as fuel cell electric vehicles (e.g., passenger vehicles or commercial vehicles), ships, and aircraft to which a fuel cell system is applied.

With reference to FIG. 1, the storage container 100 is configured to store liquid hydrogen (cryogenic liquid hydrogen) used for a fuel cell stack (not illustrated).

Hereinafter, an example will be described in which the cryogenic liquid storage apparatus 10 includes only the single storage container 100. According to another embodiment of the present disclosure, the cryogenic liquid storage apparatus may include a plurality of storage containers configured to independently store cryogenic liquids.

The storage container 100 may have various structures capable of storing the liquid hydrogen (e.g., at −253° C. based on atmospheric pressure). The present disclosure is not restricted or limited by the type and structure of the storage container 100.

With reference to FIG. 1, according to the exemplary embodiment of the present disclosure, the storage container 100 may include an inner container 110 having an accommodation space for accommodating the cryogenic liquid (e.g., liquid hydrogen), an outer container 120 configured to surround a periphery of the inner container 110, and a vacuum thermal insulation layer 130 defined between the inner container 110 and the outer container 120.

The inner container 110 and the outer container 120, which constitute the storage container 100, may be variously changed in structure and material in accordance with required conditions and design specifications. The present disclosure is not restricted or limited by the structures and materials of the inner container 110 and the outer container 120.

For example, the inner container 110 may be made of a typical thermally conductive material (e.g., metal) having thermal conductivity. According to another embodiment of the present disclosure, the inner container may be made of a multilayer thin-film thermal insulator (multilayer insulation (MLI)) or other materials.

The vacuum thermal insulation layer 130 may be provided between the inner container 110 and the outer container 120 and serve to ensure vacuum thermal insulation (vacuum insulation). Therefore, it is possible to obtain an advantageous effect of sufficiently ensuring thermal insulation performance (cryogenic thermal insulation performance) and minimizing evaporation (vaporization) of the liquid hydrogen caused by a heat inflow.

In addition, the outer container 120 may have the connection port 122 in which the level sensor 200 is mounted.

The connection port 122 may have various structures capable of mounting the level sensor 200. The present disclosure is not restricted or limited by the structure and position of the connection port 122.

For example, the connection port 122 may be provided at an upper end of the outer container 120 based on an upward/downward direction. According to another embodiment of the present disclosure, the connection port may be provided at a lateral end or other portions of the outer container. Alternatively, the connection port may be provided in a horizontal direction or inclined with respect to the upward/downward direction.

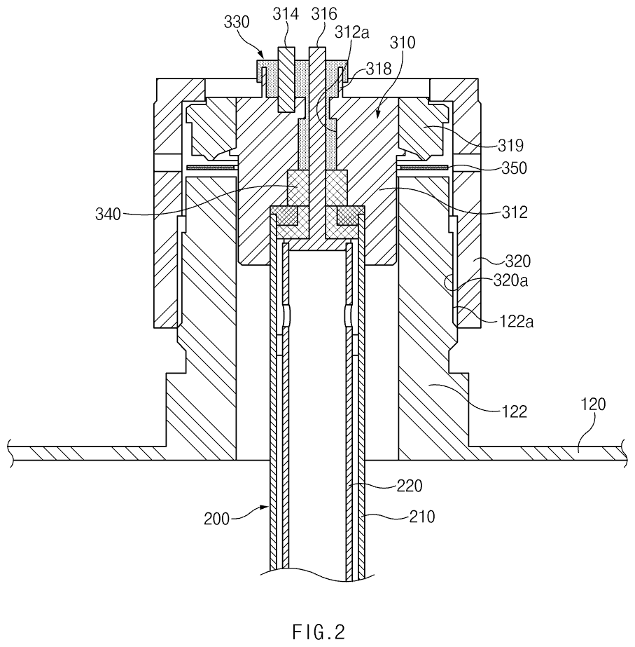

With reference to FIG. 2, the level sensor 200 is configured to detect the liquid level of the cryogenic liquid on the basis of capacitance.

Various capacitive sensors capable of detecting the liquid level of the cryogenic liquid on the basis of capacitance may be used as the level sensor 200. The present disclosure is not restricted or limited by the type and structure of the level sensor 200.

According to the exemplary embodiment of the present disclosure, the level sensor 200 may include a first electrode member 210, and a second electrode member 220 accommodated in the first electrode member 210 and electrically separated from the first electrode member 210.

For example, the first electrode member 210 may be provided in a hollow cylindrical shape, and the second electrode member 220 may be provided in a hollow cylindrical shape having an outer diameter smaller than an inner diameter of the first electrode member 210, such that the second electrode member 220 may be spaced apart from an inner surface of the first electrode member 210, provided in the first electrode member 210, and disposed coaxially with the first electrode member 210.

In the embodiment of the present disclosure illustrated and described above, the example has been described in which the first electrode member 210 and the second electrode member 220 are each provided in a hollow cylindrical shape. However, according to another embodiment of the present disclosure, the first electrode member and the second electrode member may each be provided in a straight bar shape or other shapes.

For reference, the level sensor 200 may detect the liquid level of the cryogenic liquid by measuring capacitance made by a permittivity difference of a gas (gaseous hydrogen) or a liquid (liquid hydrogen) in a gap (space) between the first electrode member 210 and the second electrode member 220.

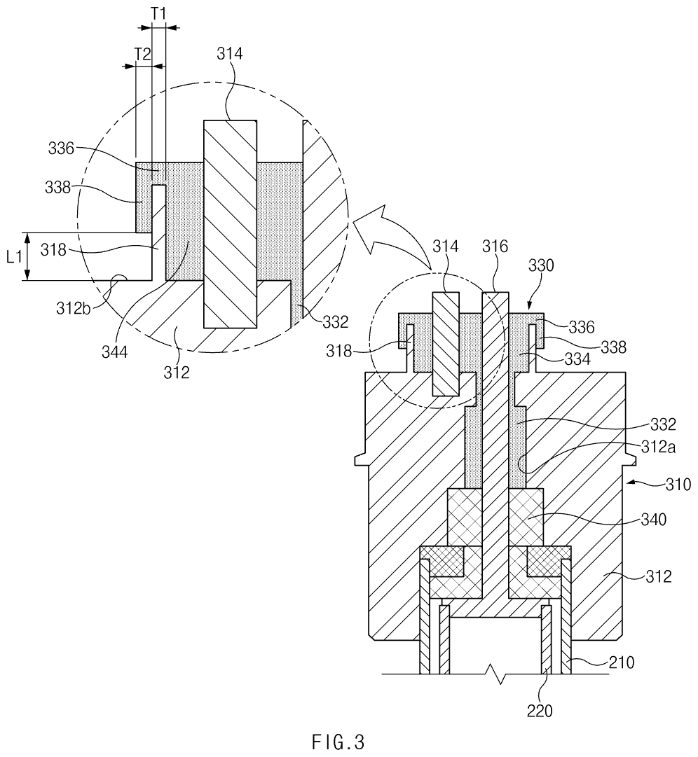

With reference to FIGS. 2 and 3, the connector part 300 is configured to selectively separably fasten the level sensor 200 to the connection port 122.

In this case, the configuration in which the connector part 300 is fastened to the connection port 122 may be defined as a configuration in which the connector part 300 is physically fastened to the connection port 122 without performing a separate welding process.

The connector part 300 may have various structures capable of selectively separably fastening the level sensor 200 to the connection port 122. The present disclosure is not restricted or limited by the structure of the connector part 300 and the method of fastening the connector part 300.

According to the exemplary embodiment of the present disclosure, the connector part 300 may include a first connector 310 configured to support one end of the first electrode member 210 and one end of the second electrode member 220 and seated in the connection port 122, and a second connector 320 configured to secure (fasten) the first connector 310 to the connection port 122.

The first connector 310 may have various structures capable of supporting one end of the first electrode member 210 and one end of the second electrode member 220 and being seated in the connection port 122. The present disclosure is not restricted or limited by the structure of the first connector 310.

According to the exemplary embodiment of the present disclosure, the first connector 310 may include a connector block 312 electrically connected to the first electrode member 210 and seated in the connection port 122, a first terminal 314 electrically connected to the connector block 312 and protruding from a reference surface of the connector block 312, and a second terminal 316 electrically separated from the first terminal 314, electrically connected to the second electrode member 220, and protruding from the reference surface of the connector block 312.

For example, the connector block 312 may be provided in the form of an approximately cylindrical block, and the first electrode member 210 may be coupled to a lower end of the connector block 312.

For example, an accommodation portion (not illustrated) may be provided in a lower portion (based on FIG. 2) of the connector block 312, and one end (an upper end) of the first electrode member 210 may be coupled to the accommodation portion so as to be tightly attached to an inner surface of the accommodation portion.

The connector block 312 may be made of a typical metallic material capable of being electrically connected to the first electrode member 210. The present disclosure is not restricted or limited by the material and properties of the connector block.

The first terminal 314 may protrude from the reference surface of the connector block 312 so as to be electrically connected to the connector block 312, and an electrical signal may be transmitted to the outside through the first terminal 314.

For example, the reference surface of the connector block 312 may be defined on an upper surface of the connector block 312 based on FIG. 2. Alternatively, the reference surface of the connector block may be defined on a lateral surface or other portions of the connector block.

The first terminal 314 may have various structures in accordance with required conditions and design specifications. The present disclosure is not restricted or limited by the structure and shape of the first terminal 314.

For example, the first terminal 314 may be provided in the form of an approximately straight rod. The first terminal 314 may be made of the same material (metal) as the connector block 312.

For example, a coupling groove (not illustrated) may be provided in an upper portion (based on FIG. 2) of the connector, and one end of the first terminal 314 may be coupled to the coupling groove so as to be tightly attached to an inner surface of the coupling groove.

The second terminal 316 may protrude from the reference surface of the connector block 312 so as to be electrically connected to the second electrode member 220 while being electrically separated from the first terminal 314. The second terminal 316, together with the first terminal 314, may transmit an electrical signal to the outside.

The second terminal 316 may have various structures capable of electrically connected to the second electrode member 220 while being electrically separated from the first terminal 314. The present disclosure is not restricted or limited by the structure and shape of the second terminal 316.

According to the exemplary embodiment of the present disclosure, the cryogenic liquid storage apparatus 10 may include a through-portion 312a provided in the connector block 312. One end of the second terminal 316 may be connected to the second electrode member 220, and the other end of the second terminal 316 may pass through the through-portion 312a and protrude from the reference surface.

For example, the second terminal 316 may have an approximately ‘T’-shaped cross-section and be made of the same material (metal) as the connector block 312. One end (a lower end based on FIG. 2) of the second terminal 316 may be connected to the second electrode member 220, and the other end (an upper end based on FIG. 2) of the second terminal 316 may pass through the through-portion 312a and protrude from the reference surface so as to be disposed in parallel with the first terminal 314.

Hereinafter, an example will be described in which the first terminal 314 and the second terminal 316 protrude from the reference surface while having the same height.

According to the exemplary embodiment of the present disclosure, the cryogenic liquid storage apparatus 10 may include an insulation member 340 provided in the connector block 312 and configured to support the second electrode member 220 and the second terminal 316 and insulate the second electrode member 220 and the second terminal 316 from the connector block 312.

The insulation member 340 is configured to support an arrangement state of the second terminal 316 with respect to the connector block 312, insulate the second electrode member 220 from the connector block 312, and insulate the second terminal 316 from the connector block 312.

The insulation member 340 may be made of a typical insulating material (e.g., synthetic resin) having an electrical insulation. The present disclosure is not restricted or limited by the material and properties of the insulation member 340.

For example, the insulation member 340 may be configured by combining a plurality of insulation blocks. The present disclosure is not restricted or limited by the number and structures of insulation blocks that constitute the insulation member 340. For example, the insulation member 340 may be configured by stacking a second insulation block having an approximately quadrangular cross-sectional shape on an upper portion of a first insulation block having an approximately ‘L’-shaped cross-section.

The second connector 320 is configured to secure the first connector 310 to the connection port 122 while exposing the first terminal 314 and the second terminal 316 to the outside.

The second connector 320 may have various structures capable of securing the first connector 310 to the connection port 122. The present disclosure is not restricted or limited by the structure and shape of the second connector 320.

For example, the second connector 320 may have an approximately ‘U’-shaped cross-section and be configured to surround an entire periphery of the first connector 310. An exposure hole (not illustrated) for exposing the first terminal 314 and the second terminal 316 to the outside may be provided at an end of the second connector 320.

In particular, the second connector 320 may be made of the same material (metal) as the connector block 312.

The method of fastening the second connector 320 and the connection port 122 may be variously changed in accordance with required conditions and design specifications. The present disclosure is not restricted or limited by the method of fastening the second connector 320 and the connection port 122.

According to the exemplary embodiment of the present disclosure, the cryogenic liquid storage apparatus 10 may include a first screw thread portion 122a provided on an outer peripheral surface of the connection port 122, and a second screw thread portion 320a provided on an inner peripheral surface of the second connector 320 and configured to engage with the first screw thread portion 122a. The second connector 320 may secure the first connector 310 to the connection port 122 by means of a fastening force between the first screw thread portion 122a and the second screw thread portion 320a.

For example, the first screw thread portion 122a may be provided in an internal thread shape, and the second screw thread portion 320a may be provided in an external thread shape. When the second screw thread portion 320a is fastened to the first screw thread portion 122a, the arrangement state of the first connector 310 with respect to the connection port 122 may be secured.

According to another embodiment of the present disclosure, the first screw thread portion may be provided in an external thread shape, and the second screw thread portion may be provided in an internal thread shape.

According to the exemplary embodiment of the present disclosure, the cryogenic liquid storage apparatus 10 may include a sealing part 330 provided on the connector block 312 and configured to surround a periphery of the first terminal 314 and a periphery of the second terminal 316.

The sealing part 330 is configured to surround the periphery of the first terminal 314 and the periphery of the second terminal 316 to seal a gap between the terminal block and the first terminal 314 and a gap between the terminal block and the second terminal 316.

The sealing part 330 may be made of various materials in accordance with required conditions and design specifications. The present disclosure is not restricted or limited by the material and properties of the sealing part 330.

According to the exemplary embodiment of the present disclosure, the sealing part 330 may be made of epoxy. Alternatively, the sealing part may also be made of Teflon or other materials.

According to the exemplary embodiment of the present disclosure, the cryogenic liquid storage apparatus 10 may include a guide rib 318 protruding from the reference surface of the connector block 312 and configured to surround the periphery of the first terminal 314 and the periphery of the second terminal 316, and the sealing part 330 may be configured to cover the guide rib 318.

The guide rib 318 may have various structures in accordance with required conditions and design specifications. The present disclosure is not restricted or limited by the structure and shape of the guide rib 318.

For example, the guide rib 318 may be integrated with the reference surface of the connector block 312 so as to have an approximately hollow cylindrical shape.

For reference, in the embodiment of the present disclosure, the configuration in which the sealing part 330 covers the guide rib 318 may be defined as a configuration in which the sealing part 330 is configured to cover an end of the guide rib 318 based on a longitudinal direction (upward/downward direction).

This is based on the fact that because the sealing part 330 (e.g., epoxy) and the first connector 310 (e.g., metal) including the guide rib 318 are made of materials with different thermal contraction ratios, the sealing performance implemented by the sealing part 330 deteriorates when an interface between the sealing part 330 and the guide rib 318 is fractured (the sealing part 330 and the guide rib 318 are separated from each other) in the event of thermal contraction of the sealing part 330. For example, it is known that a thermal contraction ratio of epoxy is about 2 to 6 times higher than a thermal contraction ratio of metal.

In contrast, according to the embodiment of the present disclosure, because the sealing part 330 covers the end of the guide rib 318, compressive stress may be applied to the guide rib 318 so that the guide rib 318 may be bent in response to the contraction of the sealing part 330 (compressive stress may be applied to allow the guide rib 318 to be bent in a direction in which the guide rib 318 approaches the first terminal 314) when the sealing part 330 contracts in a cryogenic environment. Therefore, it is possible to obtain an advantageous effect of minimizing the fracture of the interface between the sealing part 330 and the guide rib 318 (the separation of the sealing part 330 and the guide rib 318).

The sealing part 330 may have various structures capable of covering the end of the guide rib 318 while sealing the gap between the terminal block and the first terminal 314 and the gap between the terminal block and the second terminal 316. The present disclosure is not restricted or limited by the structure and shape of the sealing part 330.

According to the exemplary embodiment of the present disclosure, the sealing part 330 may include a first sealing portion 332 configured to fill a gap between the through-portion 312a and the second terminal 316, a second sealing portion 334 integrally connected to the first sealing portion 332 and configured to fill an interior of the guide rib 318, and a third sealing portion 336 integrally connected to the second sealing portion 334 and configured to cover an end of the guide rib 318.

A thickness of the third sealing portion 336 in a longitudinal direction of the first terminal 314 (the upward/downward direction based on FIG. 3) may be variously changed in accordance with required conditions and design specifications. The present disclosure is not restricted or limited by the thickness of the third sealing portion 336 in the longitudinal direction of the first terminal 314.

According to the exemplary embodiment of the present disclosure, the sealing part 330 may include a side sealing portion 338 integrally connected to the third sealing portion 336 and configured to cover a periphery of an outer surface of the guide rib 318.

The side sealing portion 338 may have various structures capable of covering the periphery of the outer surface of the guide rib 318. The present disclosure is not restricted or limited by the structure and shape of the side sealing portion 338.

For example, the side sealing portion 338 may be continuously provided at an edge of the third sealing portion 336 in a circumferential direction of the third sealing portion 336.

As described above, in the embodiment of the present disclosure, the sealing part 330 may be supported on the guide rib 318 by means of the third sealing portion 336 and the side sealing portion 338, such that compressive stress may be applied to the guide rib 318 so that the guide rib 318 may be more effectively bent in response to the contraction of the sealing part 330 when the sealing part 330 contracts in a cryogenic environment. Therefore, it is possible to obtain an advantageous effect of more effectively suppressing the fracture of the interface between the sealing part 330 and the guide rib 318 (the separation of the sealing part 330 and the guide rib 318).

According to the exemplary embodiment of the present disclosure, the side sealing portion 338 may be provided to be spaced apart from the reference surface.

A spacing distance L1 between the reference surface and the side sealing portion 338 may be variously changed in accordance with required conditions and design specifications. The present disclosure is not restricted or limited by the spacing distance L1 between the reference surface and the side sealing portion 338.

This is based on the fact that when the side sealing portion 338 adheres to the peripheral structure (e.g., the reference surface), compressive stress cannot be effectively applied to the guide rib 318 by the side sealing portion 338 when the sealing part 330 contracts. According to the embodiment of the present disclosure, the side sealing portion 338 may be disposed to be spaced apart from the reference surface, which may prevent the side sealing portion 338 and the peripheral structure (e.g., the reference surface) from being joined (coupled). Therefore, it is possible to obtain an advantageous effect of more effectively applying the compressive stress, which is applied by the side sealing portion 338, to the guide rib 318.

According to the exemplary embodiment of the present disclosure, a thickness T1 of the guide rib 318 in a longitudinal direction of the storage container 100 (a leftward/rightward direction based on FIG. 3) may be defined as 2 mm or less.

This is based on the fact that when the thickness T1 of the guide rib 318 in the longitudinal direction of the storage container 100 is larger than 2 mm, it is difficult to apply sufficient compressive stress to the guide rib 318, which may fracture the interface between the sealing part 330 and the guide rib 318. According to the embodiment of the present disclosure, the thickness T1 of the guide rib 318 in the longitudinal direction of the storage container 100 may be defined as 2 mm or less, such that flexibility of the guide rib 318 may be ensured, and sufficient compressive stress may be applied to the guide rib 318. Therefore, it is possible to obtain an advantageous effect of minimizing the fracture of the interface between the sealing part 330 and the guide rib 318.

According to the exemplary embodiment of the present disclosure, a thickness T2 of the side sealing portion 338 in the longitudinal direction of the storage container 100 (the leftward/rightward direction based on FIG. 3) may be defined as 0.5 mm or more.

In particular, the thickness T2 of the side sealing portion 338 in the longitudinal direction of the storage container 100 may be a thickness (T2=T1) corresponding to the thickness T1 of the guide rib 318 in the longitudinal direction of the storage container 100.

This is based on the fact that when the thickness T2 of the side sealing portion 338 in the longitudinal direction of the storage container 100 is less than 0.5 mm, compressive stress cannot be effectively applied to the guide rib 318 by the side sealing portion 338. According to the embodiment of the present disclosure, because the thickness T2 of the side sealing portion 338 in the longitudinal direction of the storage container 100 is defined as 0.5 mm or more, it is possible to obtain an advantageous effect of more effectively applying the compressive stress, which is applied by the side sealing portion 338, to the guide rib 318.

According to the exemplary embodiment of the present disclosure, the cryogenic liquid storage apparatus 10 may include a sealing member 350 interposed between the connection port 122 and the first connector 310.

The sealing member 350 may have various structures capable of sealing a gap between the connection port 122 and the first connector 310. The present disclosure is not restricted or limited by the structure and shape of the sealing member 350.

For example, the sealing member 350 may have a ring shape having a diameter corresponding to the connection port 122 and be interposed between an end of the connection port 122 and the first connector 310.

The sealing member 350 may be made of a typical elastic material such as rubber, silicone, or Teflon. The present disclosure is not restricted or limited by the material and structure of the sealing member 350. According to another embodiment of the present disclosure, a spring-energized seal, a metal gasket, or the like, which is made of a Teflon material, may be used as the sealing member.

With reference to FIG. 2, according to the exemplary embodiment of the present disclosure, the cryogenic liquid storage apparatus 10 may include a gland 319 connected to the first connector 310 and configured to press the sealing member 350 against the end of the connection port 122.

The gland 319 may have various structures capable of pressing the sealing member 350 so that the sealing member 350 is tightly attached to the end of the connection port 122. The present disclosure is not restricted or limited by the structure and shape of the gland 319. For example, the gland 319 may be provided in the form of a continuous ring provided along an outer peripheral surface of the connector block 312. A pressing protrusion (not illustrated), which has an approximately triangular cross-sectional shape for pressing the sealing member 350, may be provided on a bottom surface of the gland 319 that faces the end of the connection port 122.

According to the embodiment of the present disclosure described above, it is possible to obtain an advantageous effect of providing ease of maintenance and repair and improving stability and reliability.

In particular, according to the embodiment of the present disclosure, it is possible to selectively separably fasten the level sensor to the storage container.

Among other things, according to the embodiment of the present disclosure, the level sensor may be selectively mounted in or separated from the storage container without performing a welding process. Therefore, it is possible to obtain an advantageous effect of simplifying a process of assembling and maintaining and repairing the level sensor and improving workability and productivity.

In addition, according to the embodiment of the present disclosure, it is possible to obtain an advantageous effect of ensuring thermal insulation and sealability of the cryogenic liquid storage apparatus.

In particular, according to the embodiment of the present disclosure, it is possible to obtain an advantageous effect of minimizing deformation of the sealing part, which is configured to seal the periphery of the part to which the level sensor is connected, and ensuring sealability.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A cryogenic liquid storage apparatus comprising:
a storage container configured to accommodate a cryogenic liquid and having a connection port;
a level sensor configured to detect a liquid level of the cryogenic liquid on the basis of capacitance; and
a connector part configured to separably fasten the level sensor to the connection port.

2. The cryogenic liquid storage apparatus of claim 1, wherein the level sensor comprises:
a first electrode member; and
a second electrode member accommodated in the first electrode member and electrically separated from the first electrode member.

3. The cryogenic liquid storage apparatus of claim 2, wherein the connector part comprises:
a first connector configured to support one end of the first electrode member and one end of the second electrode member and seated in the connection port; and
a second connector configured to secure the first connector to the connection port.

4. The cryogenic liquid storage apparatus of claim 3, wherein the first connector comprises:
a connector block electrically connected to the first electrode member and seated in the connection port;
a first terminal electrically connected to the connector block and protruding from a reference surface of the connector block; and
a second terminal electrically separated from the first terminal, electrically connected to the second electrode member, and protruding from the reference surface of the connector block, and
wherein the second connector secures the first connector to the connection port so that the first terminal and the second terminal are exposed to the outside.

5. The cryogenic liquid storage apparatus of claim 4, further comprising:
a through-portion provided in the connector block,
wherein one end of the second terminal is connected to the second electrode member, and the other end of the second terminal passes through the through-portion and protrudes from the reference surface.

6. The cryogenic liquid storage apparatus of claim 5, further comprising:
a sealing part provided on the connector block and configured to surround a periphery of the first terminal and a periphery of the second terminal.

7. The cryogenic liquid storage apparatus of claim 6, further comprising:
a guide rib provided on the reference surface of the connector block and configured to surround the periphery of the first terminal and the periphery of the second terminal,
wherein the sealing part is configured to cover the guide rib.

8. The cryogenic liquid storage apparatus of claim 7, wherein the sealing part comprises:
a first sealing portion configured to fill a gap between the through-portion and the second terminal;
a second sealing portion connected to the first sealing portion and configured to fill an interior of the guide rib; and
a third sealing portion connected to the second sealing portion and configured to cover an end of the guide rib.

9. The cryogenic liquid storage apparatus of claim 8, further comprising:
a side sealing portion connected to the third sealing portion and configured to surround a periphery of an outer surface of the guide rib.

10. The cryogenic liquid storage apparatus of claim 9,
wherein the side sealing portion is provided to be spaced apart from the reference surface;
wherein a thickness of the guide rib in a longitudinal direction of the storage container is defined as about 2 mm or less; and/or
wherein a thickness of the side sealing portion in a longitudinal direction of the storage container is defined as about 0.5 mm or more.

11. The cryogenic liquid storage apparatus of claim 6, wherein the sealing part comprises epoxy.

12. The cryogenic liquid storage apparatus of claim 4, further comprising:
an insulation member provided in the connector block and configured to support the second electrode member and the second terminal and insulate the second electrode member and the second terminal from the connector block.

13. The cryogenic liquid storage apparatus of claim 3, further comprising:
a sealing member interposed between the connection port and the first connector.

14. The cryogenic liquid storage apparatus of claim 13, further comprising:
a gland connected to the first connector and configured to press the sealing member against an end of the connection port.

15. The cryogenic liquid storage apparatus of claim 3, further comprising:
a first screw thread portion provided on an outer peripheral surface of the connection port; and
a second screw thread portion provided on an inner peripheral surface of the second connector and configured to engage with the first screw thread portion,
wherein the second connector secures the first connector to the connection port by means of a fastening force between the first screw thread portion and the second screw thread portion.

16. The cryogenic liquid storage apparatus of claim 1, wherein the storage container further comprises:
an inner container configured to accommodate the cryogenic liquid; and
an outer container configured to surround a periphery of the inner container, and
wherein the connection port is provided in the outer container.

17. The cryogenic liquid storage apparatus of claim 16, further comprising:
a vacuum thermal insulation layer defined between the inner container and the outer container.

18. The cryogenic liquid storage apparatus of claim 3, wherein all components of the first connector are made of the same material.

19. A cryogenic liquid storage apparatus comprising:
a storage container configured to accommodate a cryogenic liquid and having a connection port;
a level sensor configured to detect a liquid level of the cryogenic liquid on the basis of capacitance, the level sensor comprising:
a first electrode member;
a second electrode member accommodated within the first electrode member and electrically separated from the first electrode member; and
a connector part configured to separably fasten the level sensor to the connection port, the connector part including a sealing structure to ensure a hermetic seal between the level sensor and the connection port.

20. A cryogenic liquid storage apparatus comprising:
a storage container configured to accommodate a cryogenic liquid, the storage container comprising:
an inner container configured to accommodate the cryogenic liquid;
an outer container configured to surround a periphery of the inner container and having a connection port; and
a vacuum thermal insulation layer defined between the inner container and the outer container;
a level sensor configured to detect a liquid level of the cryogenic liquid on the basis of capacitance, the level sensor comprising:
a first electrode member;
a second electrode member accommodated within the first electrode member and electrically separated from the first electrode member; and
a connector part configured to separably fasten the level sensor to the connection port.
